(19) United States
(12) Patent Application Publication
(10) Pub. No.: US 2020/0184497 A1
(43) Pub. Date: Jun. 11, 2020

(54) CUSTOMER SATISFACTION DATABASE MANAGEMENT SYSTEM

(71) Applicant: Michael Meyer, Willowbrook, IL (US)

(72) Inventor: Michael Meyer, Willowbrook, IL (US)

(21) Appl. No.: 16/440,599

(22) Filed: Jun. 13, 2019

Related U.S. Application Data
(60) Provisional application No. 62/775,644, filed on Dec. 5, 2018.

(51) Int. Cl. G06Q 30/02

(52) U.S. Cl. CPC G06Q 30/0203

(57) ABSTRACT

Embodiments of the disclosed system and methods address the above problems by providing a central repository of data collected from past customers (or potential customers) during interactions with a variety of vendors, and by permitting vendors to access that data (and analyses derived from that data) in a meaningful way. In particular, after collecting customer (or potential customer) data, embodiments of the disclosed system perform certain data processing and analytics to normalize the data based on the customer's past feedback, and present that modified data to a vendor accessing the system. This permits the vendor to compare, customer-for-customer, previously-provided feedback data and adjust the sales approach and process accordingly.

### PRIORITY CLAIM

This application claims priority to and the benefit as a continuation application of U.S. patent application Ser. No. 62/775,644 entitled “Customer Satisfaction Database Management System,” filed Dec. 5, 2018, the entire contents of which are hereby incorporated by reference herein and relied upon.

### FIELD OF THE INVENTION

Various embodiments of the present invention provide a system and methods for beneficially permitting vendors to access and review previously-provided customer satisfaction information in a real-time, on-demand way. In addition, embodiments of the system and methods disclosed herein provide data analytics and analysis that can beneficially be achieved by accumulating and storing data from previously-provided customer satisfaction responses. In some embodiments, the system and methods disclosed herein find particular applicability in the retail sales space, and more particularly in assisting car dealers in interacting with their customers.

### BACKGROUND

In certain retail sales environments, and particularly in retail sales environments where the goods and services being sold relate to automotive products (e.g., car dealerships), vendors face a problem when the same vendor or business attempts to deliver identical or very similar products or services to customers in the same or very similar fashion. In particular, in this scenario, customers often provide feedback to a vendor that vary, sometimes substantially, depending on the customer's proclivities and particularities, and not based on the quality of the delivered product or service. For example, good customers may generally give good surveys and bad customers may generally give bad surveys. Additionally, may customers may think they are responding with “good” surveys scores, but in reality are not. Accordingly, while survey data reflecting customer feedback can be a useful tool, vendors often find it difficult or impossible to identify areas of improvement in the delivery of the good or service, versus to discern differences in feedback arising from the fact that different customers are providing it. Additionally, it can take seven perfect surveys to make up for a single bad survey result, thereby negatively skewing survey results.

Another known problem is that it is impossible to see customer survey data derived not just from a particular vendor, but from other vendors of the same or similar types of goods and services. This is partially due to the lack of a database system that accumulates all these disparate types of data, and also partially due to the lack of a technique for normalizing the feedback in a meaningful, useful way.

What is needed is a system and method to provide vendors with useful data reflective of customer survey or other feedback data, such that customer feedback is normalized according to how that customer has responded on past occasions. Additionally or alternatively, a system and method is needed to prevent bad survey results before they happen. Additionally or alternatively, a system and method is needed to solicit surveys from good customers. Additionally or alternatively, a system and method is needed to thank customers who provide good surveys. Additionally or alternatively, a system and method is needed to help a vendor/business make informed decisions on goodwill based on a customer's survey history. Additionally or alternatively, a system and method is needed to aid a vendor/business to make decisions based on customer surveys without access to the vendor/business's private computer systems.

The system and methods described herein provide this solution, and advantageously enable vendors to reliably use customer data that has been normalized or otherwise averaged based on a customer's past responses to permit data to be compared customer-to-customer. This permits vendors to identify areas of improvement, either in the vended goods and services or in the sales experience, to sell more goods and services and to more reliably predict how much of a particular good or service will be sold.

### SUMMARY

Embodiments of the disclosed system and methods address the above problems by providing a central repository of data collected from past customers (or potential customers) during interactions with a variety of vendors, and by permitting vendors to access that data (and analyses derived from that data) in a meaningful way. In particular, after collecting customer (or potential customer) data, embodiments of the disclosed system perform certain data processing and analytics to normalize the data based on the customer's past feedback, and present that modified data to a vendor accessing the system. This permits the vendor to compare, customer-for-customer, previously-provided feedback data and adjust the sales approach and process accordingly.

In one embodiment, the system and methods disclosed herein store data from numerous related and unrelated businesses and normalize the different scoring scales into a uniform scale. This beneficially permits customer feedback data to be compared across customers, vendors, and even products, as biases in particular customers' provision of feedback can be minimized or eliminated.

### BRIEF DESCRIPTION OF THE FIGURES

FIG. 1 illustrates an exemplary block diagram of a host device usable to implement a feedback system and aggregation system according to the present disclosure.

FIG. 2 illustrates a screenshot representing an exemplary embodiment of a feedback and aggregation system according to the present disclosure.

FIG. 3 illustrates a screenshot representing an additional or alternative exemplary embodiment of a feedback and aggregation system according to the present disclosure.

FIG. 4 illustrates a screenshot representing an embodiment of an aggregated customer feedback list of a feedback and aggregation system according to the present disclosure.

FIG. 5 illustrates a screenshot representing an additional or alternative embodiment of an aggregated customer feedback list of a feedback and aggregation system according to the present disclosure.

FIG. 6 illustrates a screenshot representing an additional or alternative embodiment of an aggregated customer feedback list of a feedback and aggregation system according to the present disclosure.

FIG. 7 illustrates a screenshot representing an embodiment of a vendor/business dashboard interface operating with a feedback and aggregation system according to the present disclosure.

FIG. 8 illustrates a screenshot representing an additional or alternative embodiment of a vendor/business dashboard interface operating with a feedback and aggregation system according to the present disclosure.

FIG. 9 illustrates a screenshot representing an additional or alternative embodiment of a vendor/business dashboard interface operating without a feedback and aggregation system according to the present disclosure.

FIG. 10 illustrates a screenshot representing an additional or alternative embodiment of a vendor/business dashboard interface operating without a feedback and aggregation system according to the present disclosure.

FIG. 11 illustrates a screenshot representing an embodiment of an aggregated customer feedback database of a feedback and aggregation system according to the present disclosure.

FIG. 12 illustrates a screenshot representing an embodiment of a personalized customer communication of a feedback and aggregation system according to the present disclosure.

FIG. 13 illustrates a process flow diagram of an embodiment of an aggregated customer feedback list of a feedback and aggregation system according to the present disclosure.

### DETAILED DESCRIPTION

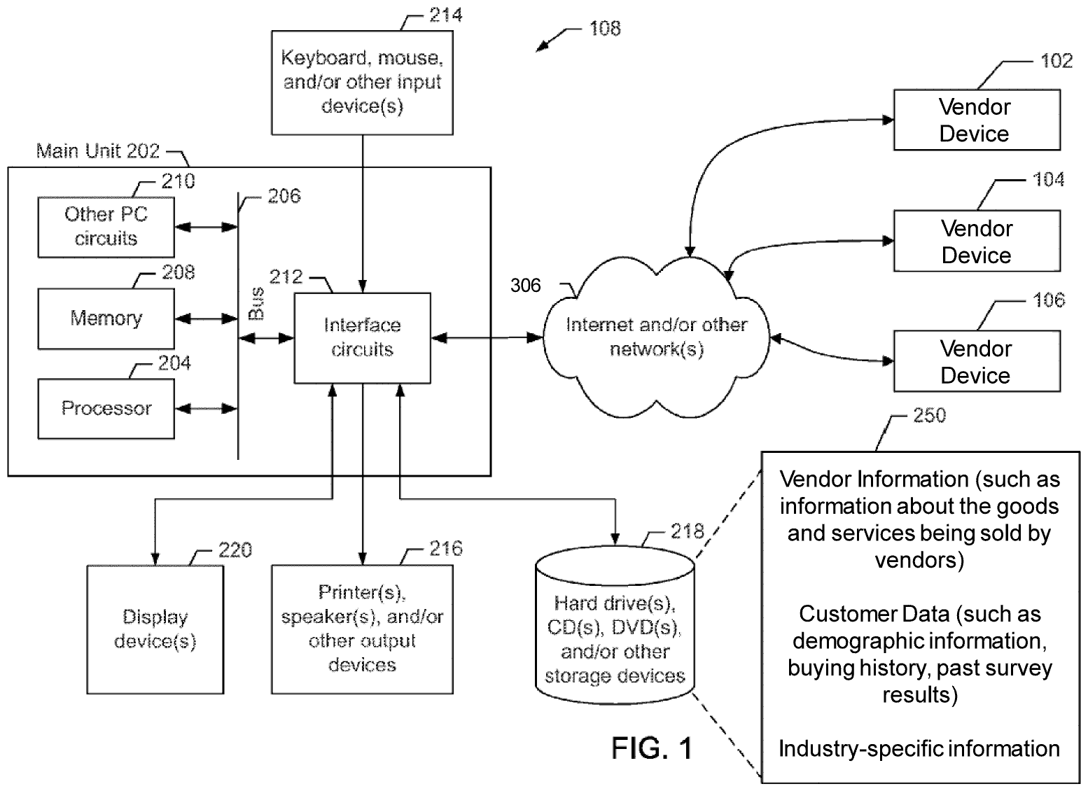

FIG. 1 is a block diagram illustrating an example of the electrical systems of a host device (e.g., host device 108) usable to implement the customer feedback and aggregation system disclosed herein. In one embodiment, the host device 108 illustrated in FIG. 1 corresponds to survey data host device to connect vendors of goods or services (such as automotive goods or services, e.g., car dealers) to a centralized database of information about actual or prospective customers of the pertinent goods/services. In this embodiment, the vendors interact with the host device 108 using vendor devices 102, 104 or 106. In other embodiments, the customers can interact directly with host device 108, such as through one of the devices 102, 104, or 106.

In the example architecture illustrated in FIG. 1, the host device 108 includes a main unit 202 which preferably includes one or more processors 204 electrically coupled by an address/data bus 206 to one or more memory devices 208, other computer circuitry 210, and/or one or more interface circuits 212. The one or more processors 204 may be any suitable processor, such as a microprocessor from the INTEL PENTIUM® family of microprocessors. PENTIUM® is a trademark registered to Intel Corporation and refers to commercially available microprocessors.

In one embodiment, host device 108 includes memory 208. Memory 208 preferably includes volatile memory and non-volatile memory. Preferably, the memory 208 stores one or more software programs that interact with the hardware of the host device 108 and with the other devices in the system as described below. In addition or alternatively, the programs stored in memory 208 may interact with one or more vendor devices, such as device 102, to enable vendors of goods and services to interact with the customer feedback and aggregation system described herein.

The programs stored in memory 208 may be executed by the processor 204 in any suitable manner. The memory 208 may also store digital data indicative of intangible information, such as information about an individual shopping for goods/services, the goods/services themselves, and/or past survey results from a plurality of customers or potential customers. This information may be received from device 102 based on inputs made by one of the vendors that can access the disclosed system, or may be provided directly by a customer providing feedback about a shopping experience. In some embodiments, the disclosed system receives input data from third-party sources, such as from third-party websites. In these embodiments, host device 108 is configured to communicate with such third-party sources of data via an appropriate network connection, such as through cloud 306.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system. In one embodiment, wherein the host device 108 is designed to be operated or interacted with only via remote devices, the host device 108 does not include input devices 214.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual representations of data during operation of the host device 108. For example, the display 220 may be used to display a representation of at least a portion of one or more pieces of information, such as one or more pieces of data about a customer or potential customer. In particular, the display 220 may display the normalized data reflective of a particular customer's past feedback to one or more vendors accessing the customer feedback and aggregation system described herein. In one embodiment, the host device 108 does not include a display, and access to the host device 108 is performed substantially entirely through devices 102, 104, and/or 106.

One or more storage devices 218 may also be connected to the main unit 202 via the interface circuit 212. For example, a hard drive (including a solid state drive), CD drive, DVD drive, and/or other storage devices may be connected to the main unit 202. The storage devices 218 may store any type of data used by the host device 108. In one example the storage device 218 stores database information 250 including vendor information (such as information about the goods and services being sold by vendors that can access host device 108), customer data (including demographic information, buying history, past survey results, and the like), and industry-specific information needed to assess and analyze the data stored in the database 250. Further, the storage device 218 may also include database 250 that includes data needed to facilitate the actual provision of data to and accessing of data from the host device 108, such as web site information, survey entry information, security credential validation information, and the like.

Preferably, the connection of devices (i.e., the host device 108 and the devices 102, 104, and 106) is facilitated by a network connection over the Internet and/or other networks, illustrated in FIG. 1 by cloud 306. The network connection may be any suitable network connection, such as an Ethernet connection, a digital subscriber line (DSL), a WiFi connection, a cellular data network connection, a telephone line-based connection, a connection over coaxial cable, or another suitable network connection.

Access to devices 102 through 108 may be controlled by appropriate security software or security measures. An individual user's access can be defined by the host device 108 and limited to certain data and/or actions.

In a preferred embodiment, each of the remote devices 102, 104, and 106 has a similar structural or architectural makeup to that described above with respect to the host device 108. That is, each remote device in an embodiment includes a display device, at least one input device, at least one memory device, at least one storage device, at least one processor, and at least one network interface device. It should be appreciated that by including such components, which are common to well-known desktop, laptop, or mobile computer systems (including smart phones, tablet computers, and the like), devices 102, 104, and 106 can readily interact with each other and with host device 108.

In various embodiments, devices 102, 104, 106, and/or 108 as illustrated in FIG. 1 may in fact be implemented as a plurality of different devices. For example, the host device 108 may in actuality be implemented as a plurality of server devices operating together to provide access by a plurality of vendors to a centralized repository of information reflective of customer feedback data, whether it be actual feedback data or normalized (or otherwise processed) data reflecting a more universally applicable representation of customer feedback data. Moreover, in one embodiment, at least one of the devices 102, 104, and 106 may be accessible to a user using a telephone or other device remote from devices 102, 104, 106, and 108.

Using systems having architectures similar to that shown in FIG. 1, the disclosed system advantageously provides a seller/vendor business with a degree of predictability how a customer has previously (and would in the future) respond to a survey about the sales process. Embodiments of the disclosed system thus permit the business to invoke special processes for customer with a high probability of both a good or a bad survey. That is, when a vendor first interacts with a customer, the vendor can pull past history about the customer's experiences and can predict and/or respond to a predicted good or bad reaction by the customer.

Embodiments of the disclosed system also permit the vendor/business to decide whether or not to solicit a survey from the customer. That is, if the vendor knows from a customer's past surveys that he or she might react more negatively than is actually warranted in view of the customer's experiences, the business may elect not to solicit the survey from the customer so as not to skew the overall survey data. In such embodiments, the disclosed system improves overall customer satisfaction scores for a particular vendor (as well as the likelihood of closing sales). This benefits the vendor in several ways, including by resulting in the ability to truthfully advertise higher customer satisfaction, win awards for both sales and customer satisfaction, increase customer retention rates, and in some cases obtain cash rewards provided to vendors based on customer satisfaction survey results.

In one embodiment, the disclosed system is a customer feedback management system comprising at least one processor, at least one display device, at least one input device, and at least one memory device storing a plurality of instructions which, when executed by the at least one processor, cause the at least one processor to operate with the at least one input device and the at least one display device to facilitate the various interactions described herein. In particular, the disclosed system in one embodiment permits a plurality of customers to each provide a plurality of inputs reflective of that customer's experiences with a vendor of goods/services, for each of said plurality of customers, determines an adjustment factor to apply to the plurality of inputs for that customer to generate a normalized indication of that customer's experiences with the vendor of goods/services, receives at least one input from said vendor of goods/services reflective of a new interaction with a selected one of said plurality of customers, and displays the adjustment factor for said selected customer.

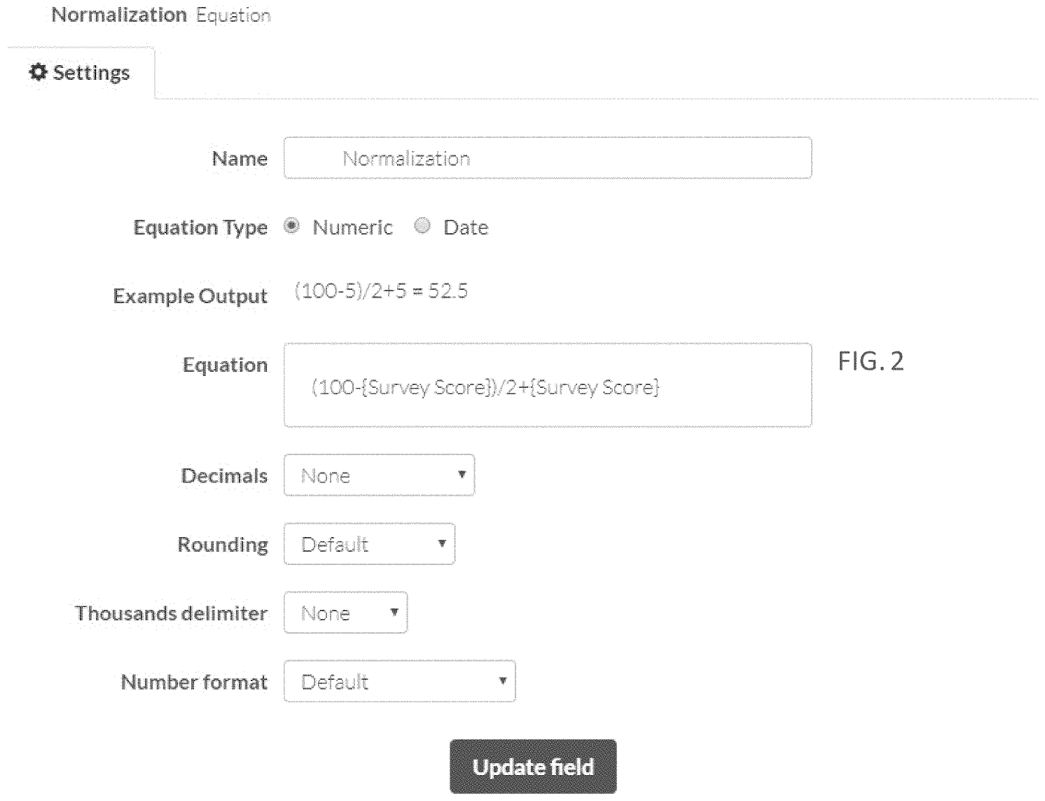

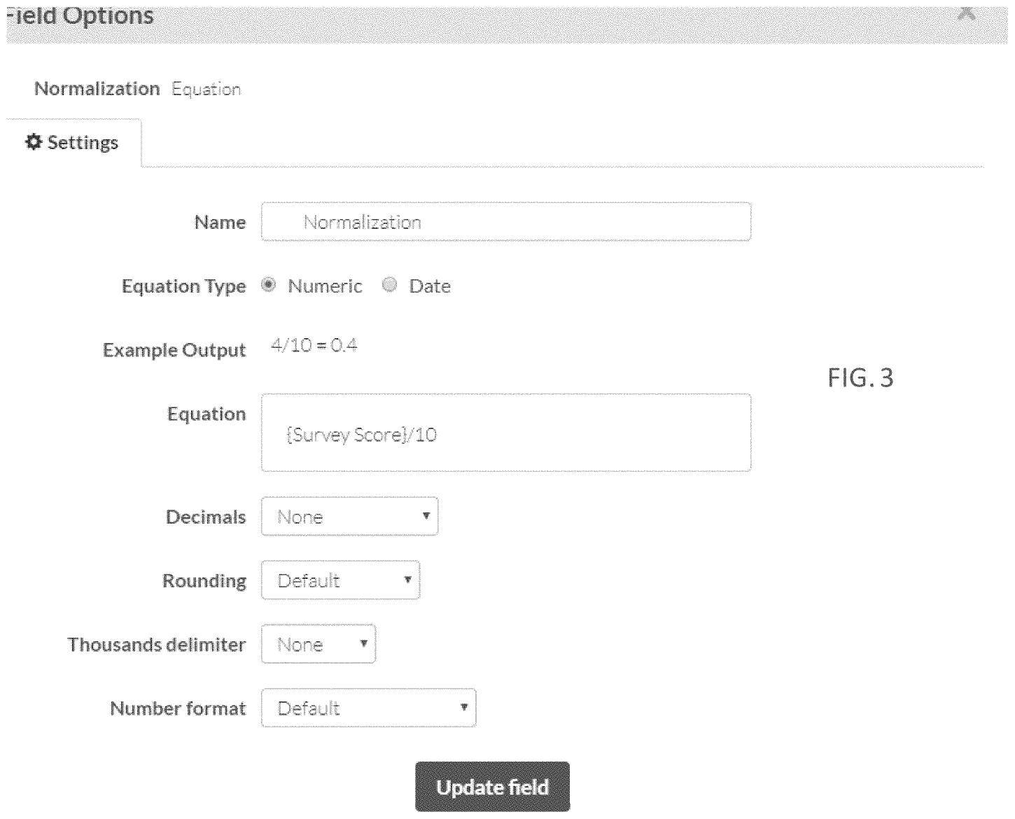

FIGS. 2 and 3 illustrate screen shots representing an exemplary embodiment of the disclosed system in which the vendor is a car dealer and the customer or prospective customer data includes survey data generated by prospective customers of the car dealer. In this embodiment, surveys about a first car vendor (as shown in FIG. 2) have a range from −100 to 100. Accordingly, in connection with FIG. 2, the disclosed system normalizes the potential scores by performing the following equation: (100-Survey Score/2)+Survey Score. Also in this embodiment, in connection with FIG. 3, the second car vendor has a score that can be normalized simply by dividing the survey score by 10. In this embodiment, the disclosed system averages all the normalized scores, making them usable by the vendor on a scale from 0 to 100.

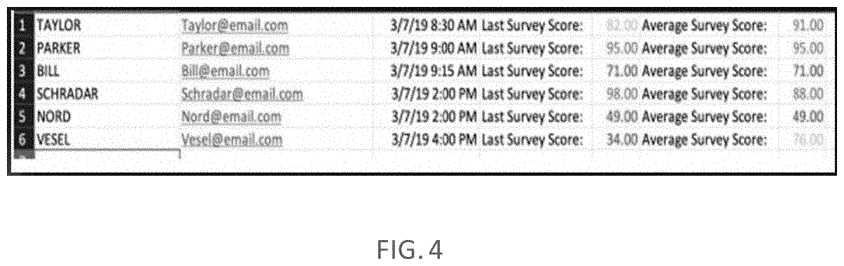

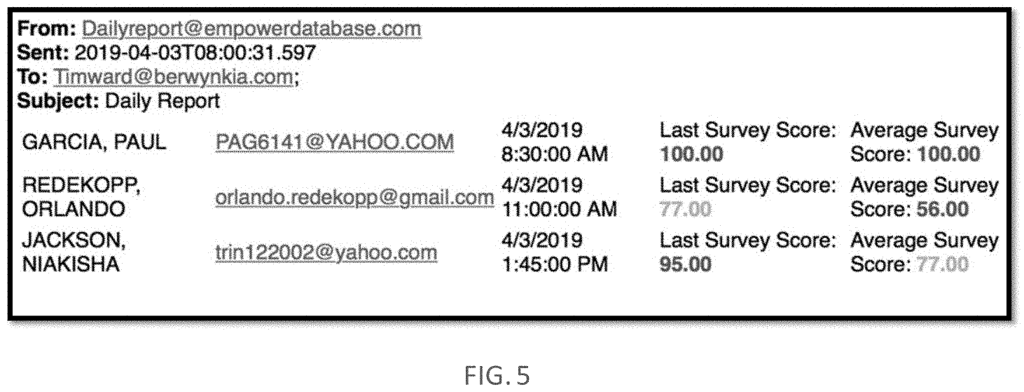

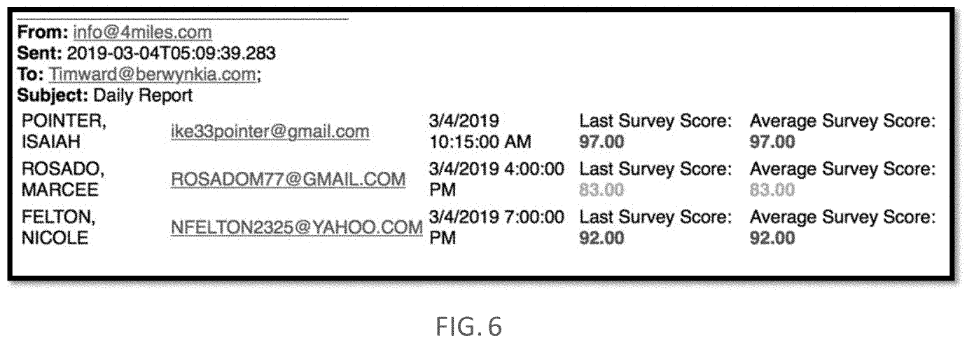

FIGS. 4 to 6 illustrate screenshots representing an embodiment of an aggregated customer feedback list of a feedback and aggregation system. In this embodiment, a list of customers is provided. Each customer entry in the customer list may include additional information such as contact information (i.e., a customer name, an email address, a phone number and/or a physical address), a time the customer last completed a customer survey, a date the customer last completed a customer survey, a last survey score, and/or an average survey score. The average survey score may represent a normalized survey score calculated by the feedback and aggregation system. In an embodiment, each customer survey may be color coded to allow the vendor/business to easily identify customer feedback information. For example, a normalized survey score of a customer entry may coded green for a score that is greater than 85, yellow for a score that is between 80 and 84, and/or red for a score that is 79 or less. In an embodiment, the vendor/business may use the aggregated customer feedback list to decide whether or not to solicit a survey from a customer. In an embodiment, the aggregated customer feedback list may be sent to the vendor/business twice daily to assist the vendor/business in determining whether or not to solicit a survey from a customer.

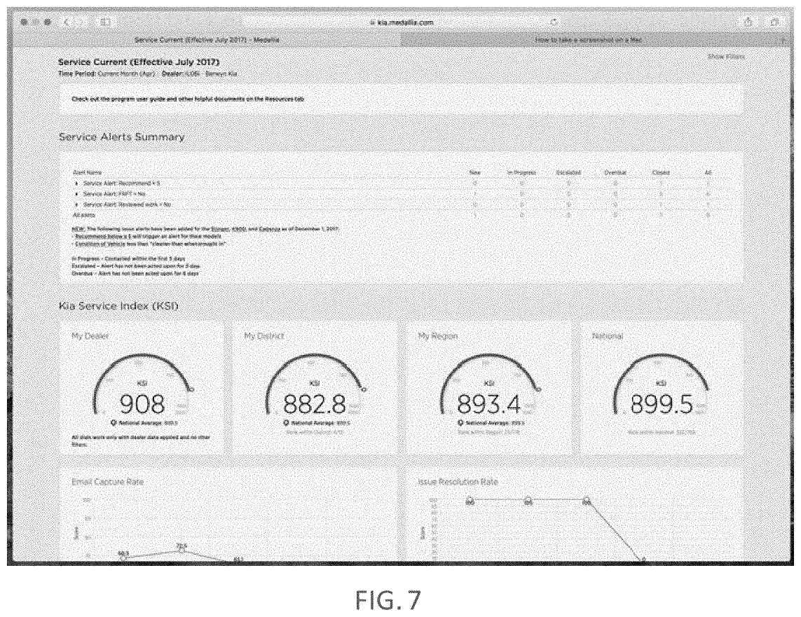

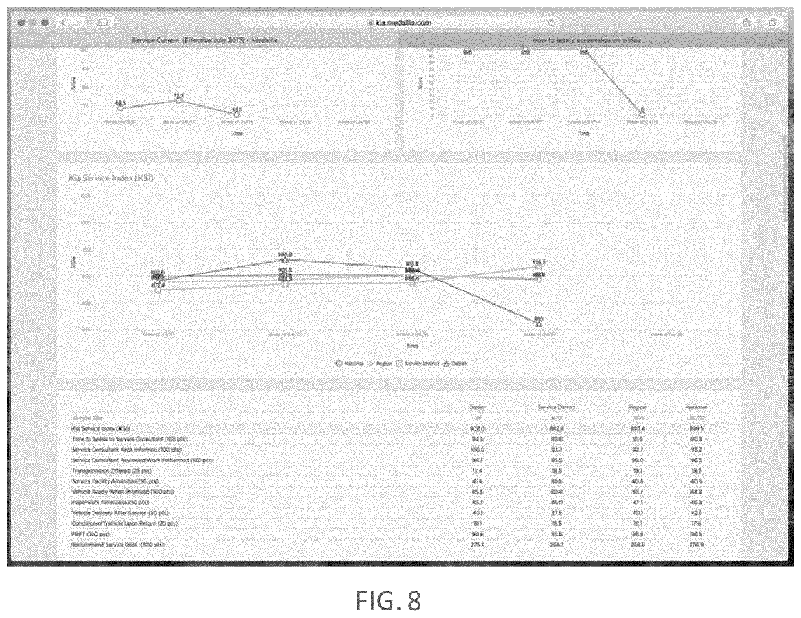

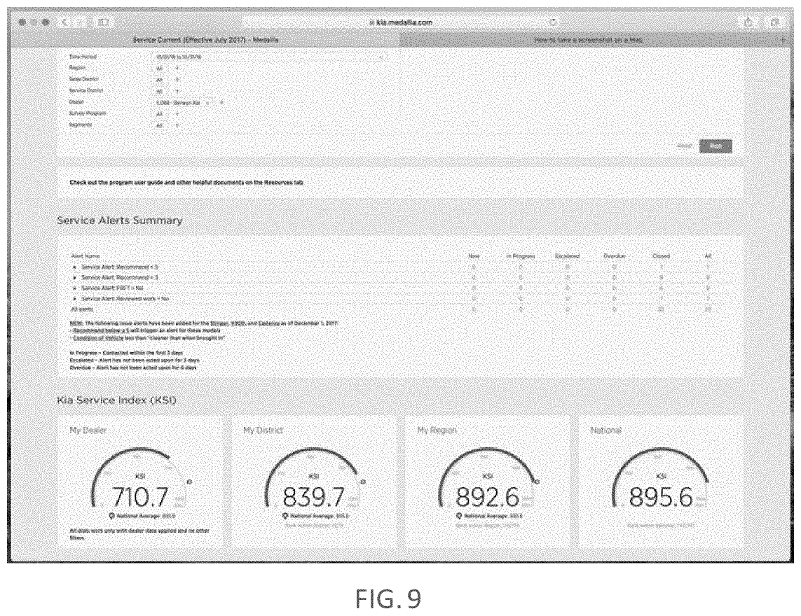

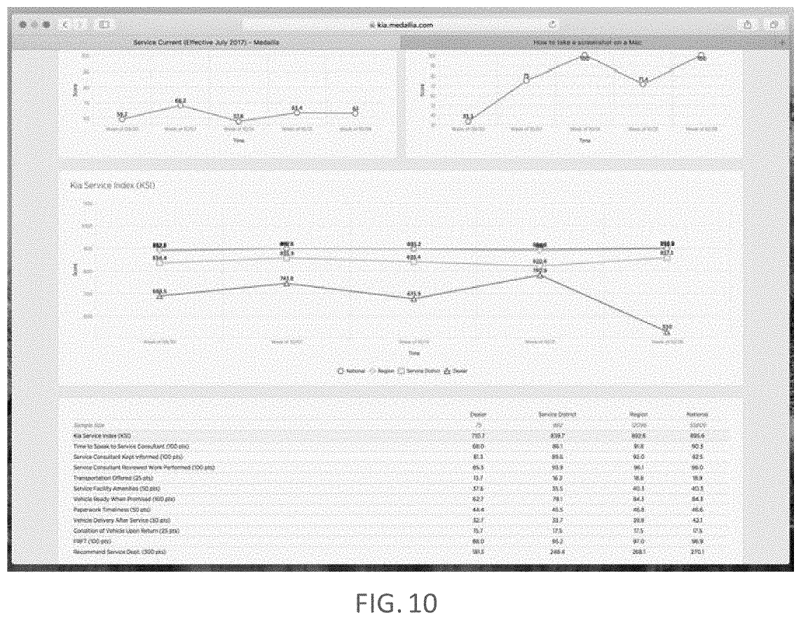

FIGS. 7 and 8 illustrate screenshots representing an embodiment of a vendor/business dashboard interface (i.e., a vendor device and/or a display device) operating with a feedback and aggregation system. FIGS. 9 and 10 illustrate screenshots representing an embodiment of a vendor/business dashboard interface (i.e., a vendor device and/or a display device) operating without a feedback and aggregation system. For example, in FIGS. 7 to 10 a standard vendor/business dashboard interface used in a KIA® dealership is shown. In an embodiment, the vendor/business dashboard interface includes a service alerts summary. The service alerts summary may indicate a need to follow-up with a customer regarding a completed customer survey; display statistics relating to open, completed, and/or in progress customer surveys; display customers that require and/or are overdue for service; display timing information regarding customer surveys; and/or display and/or aggregate other information. In an embodiment, the vendor/business dashboard interface may illustrate a raw and/or aggregate: dealer customer survey score; district customer survey score; region customer survey score; national customer survey score; and/or other customer survey score. In an embodiment, an aggregate customer survey score may be represented by an index.

In an embodiment, the dealer customer survey score may include a raw and/or aggregate customer survey score from a single vendor/business. In an embodiment, the district customer survey score may include a raw and/or aggregate customer survey score from a group of vendors/businesses corresponding to a geographical area. In an embodiment, the district customer survey score includes scores from thirteen vendors/businesses. In an embodiment, the region customer survey score may include a raw and/or aggregate customer survey score from a group of vendors/businesses corresponding to a larger geographical area than the geographical area corresponding to the district customer survey score. In an embodiment, the national customer survey score may include a raw and/or aggregate customer survey score from a group of vendors/businesses corresponding to a larger geographical area than the geographical area corresponding to the region customer survey score. In an embodiment, the national customer survey score includes scores from seven-hundred vendors/businesses.

In an embodiment, an index may be adjustable to limit customer feedback to only selected events. For example, an index may only display aggregate customer survey scores from customers purchasing a product from a single source, from a single brand, or who purchased a particular service. In an embodiment, the vendor/business dashboard interface may be configurable to adjust and/or reformat data displayed on the vendor/business dashboard interface. Referring specifically in an embodiment shown in FIGS. 7 and 8, the vendor/business dashboard interface communicates with the feedback and aggregation system to display data compiled and/or normalized by the feedback and aggregation system.

Referring now in particular to FIGS. 8 and 10, the vendor/business dashboard interface may display data as a histogram (i.e., present scores relative to time) and/or display a list of customer feedback events. In an embodiment, the list is sortable by, for example, a geographic location where customer interaction with the vendor/business that precipitated a customer survey originated. In an embodiment, the vendor/business dashboard interface may display the index representing the aggregate customer survey score. Referring specifically to FIG. 8, the vendor/business dashboard interface may display data compiled and/or normalized by the feedback and aggregation system according to any of the above-referenced embodiments.

In the examples provided by FIGS. 7 to 10, advantages of the system, device, and/or method according to the present disclosure may be illustrated. For example, the vendor/business dashboard interface in FIG. 9 illustrates a dealer customer survey score (e.g., 710.7 out of 1000 possible points) where the data is not processed and/or normalized using the feedback and aggregation system as disclosed herein. In contrast, FIG. 7 illustrates a dealer customer survey score (e.g., 908 out of 1000 possible points) where the data has been processed and/or normalized using the feedback and aggregation system as disclosed herein. Accordingly, the increased dealer customer survey score shown in FIG. 7 compared to the scores shown in FIG. 9 (i.e., 908 compared to 710.7) are attributable to the system, device, and/or method according to the present disclosure.

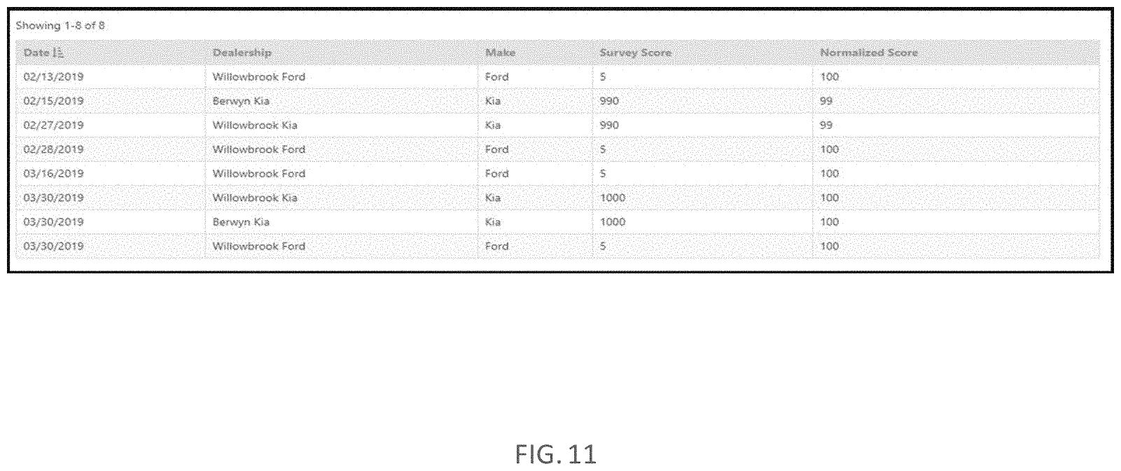

FIG. 11 illustrates a screenshot representing an additional or alternative embodiment of an aggregated customer feedback database of a feedback and aggregation system. In an embodiment pertaining in particular to automotive dealership data, the database may include information with a customer survey including a customer survey date, a dealership name where the customer survey originated and/or the customer interaction occurred, a make/model of the subject car of the survey and/or a dealership brand where the customer survey originated, a raw survey score, and/or a normalized survey score. As shown in FIG. 11, through the systems and methods according to the present disclosure, vastly different raw survey scores (i.e., with numerical values of 5, 990 and/or 1000) may be normalized such that each score is comparable between, for example, car dealerships with different raw survey score outcomes. In an embodiment, the data base may be sortable to aggregate and/or omit customer survey scores according to a desired metric. For example, any customer survey score from a KIA® dealership may be omitted within the sortable database.

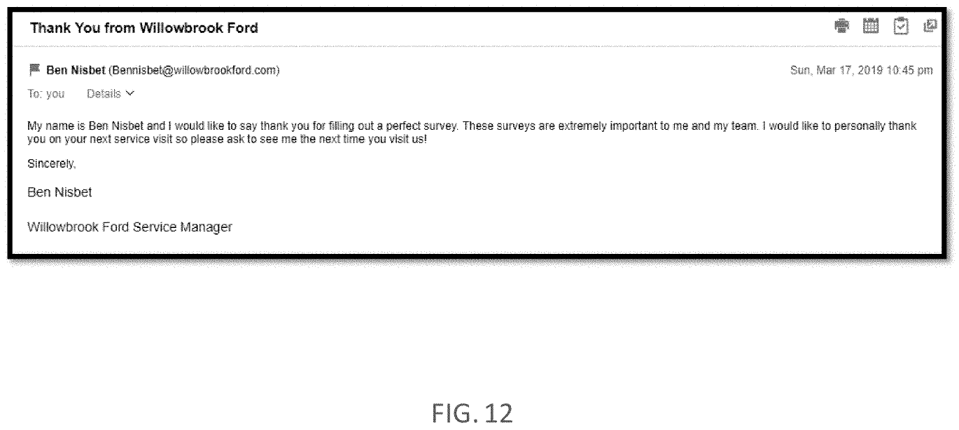

FIG. 12 illustrates a screenshot representing an embodiment of a personalized customer communication of a feedback and aggregation system. In an embodiment, the customer communication is an email. In an embodiment, the feedback and aggregation system generates a customer communication when a customer completes a feedback survey with a certain normalized score. For example, the feedback and aggregation system generates a customer communication when a customer completes a survey with a normalized score over 95. In an embodiment, the customer communication may be customized for a specific car dealership. In an embodiment, the personalized customer communication is an email sent from a vendor/business email address. For example, if the vendor/business is a car dealership, the email may be sent from the email address used by the service manager of the car dealership. In such an embodiment, customer responses to the email may be delivered directly to the service manager/email address from where the email originated. Such an embodiment may help to build rapport with customers of the vendor/business.

In an embodiment, the personalized customer communication is a phone call. In such an embodiment, the personalized customer communication may be a voicemail left at a customer phone number. In an embodiment, customers may be called by the advisor who interfaced with the customer at the dealership. In an embodiment, the phone call is used in conjunction with an email. In an embodiment, the phone number used to call a customer is a number originating from the vendor/business. In an embodiment, customers may be called Monday through Saturday. In an embodiment, customers who answer the phone call and/or customers reporting an issue relating to their vendor/business experience may be transferred to an alternative number/extension. In an embodiment, reporting communications may be sent to an employee, for example a service manager, to report the results from the personalized customer communications.

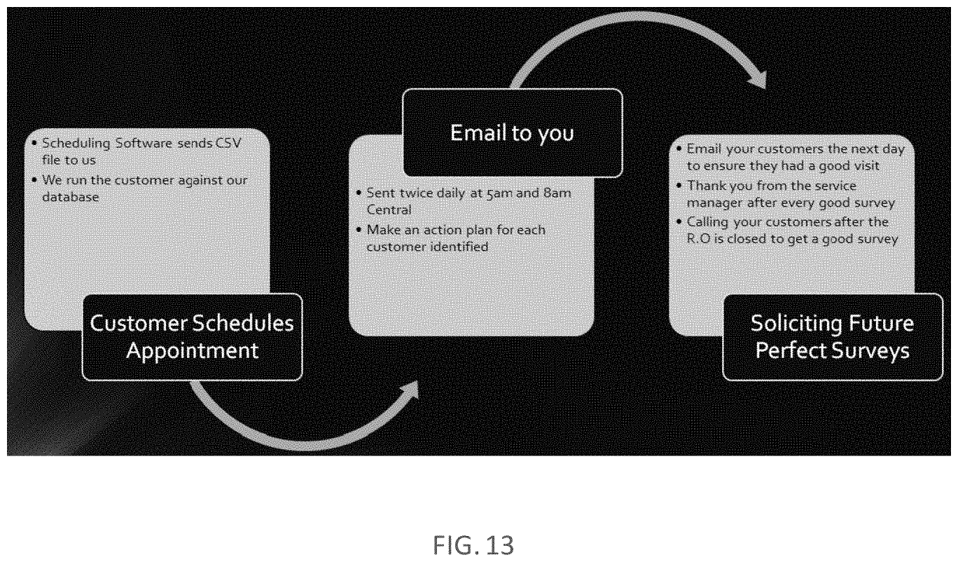

FIG. 13 illustrates a process flow diagram of an embodiment of an aggregated customer feedback list of a feedback and aggregation system. In an embodiment according to FIG. 13, a customer may schedule an appointment with a vendor/business. When the customer schedules the appointment, the feedback and aggregation system may deliver a report communicating that a customer appointment was scheduled. In an embodiment, the report may be in the form of a CSV, or comma-separated values, file. Then, the customer information for the customer that scheduled the appointment may be compared to customer information stored by the feedback and aggregation system to identify the customer in the feedback and aggregation system. The customer information stored by the feedback and aggregation system may be past customer survey results provided by the vendor/business and/or other vendors/businesses. Then, if a customer is identified within the feedback and aggregation system, the feedback and aggregation system may create an action plan for the customer. For example, an email may be sent to the vendor/business reporting information (i.e., past customer survey results from the customer) regarding the customer. Additionally or alternatively, the action plan may include emailing and/or calling the customer the next day to ensure the customer had a good visit with the vendor/business, sending a thank-you communication to the customer from an employee at the vendor/business, and/or calling the customer after completion of the appointment/service at the vendor/business to ensure a good customer survey result. Emailing and/or calling the customer the next day may help to catch customers before they give a bad survey and/or encourage good customers to give another good survey. Emailing and/or calling the customer may further serve to educate a customer how to respond to a survey to give an intended good survey result in a case where the customer believes that he or she is giving a good survey result, but in reality is not in reality giving such a result.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

The invention is claimed as follows:

1. An customer feedback management system comprising:
at least one processor;
at least one display device;
at least one input device; and
at least one memory device storing a plurality of instructions which, when executed by the at least one processor, cause the at least one processor to operate with the at least one input device and the at least one display device to:
(a) permit a plurality of customers to each provide a plurality of inputs reflective of that customer's experiences with a vendor of goods/services;
(b) for each of said plurality of customers, determine an adjustment factor to apply to the plurality of inputs for that customer to generate a normalized indication of that customer's experiences with the vendor of goods/services;
(c) receive at least one input from said vendor of goods/services reflective of a new interaction with a selected one of said plurality of customers; and
(d) display the adjustment factor for said selected customer.

2. The customer feedback management system of claim 1, wherein the new interaction comprises a follow-up email.

3. The customer feedback management system of claim 1, wherein the new interaction comprises a follow-up phone call.

4. The customer feedback management system of claim 1, wherein the new interaction comprises a customer appointment with the vendor of goods/services.

5. The customer feedback management system of claim 1, wherein the vendor of goods/services is a car dealership.

6. The customer feedback management system of claim 1, wherein the inputs reflective of that customer's experiences are based on a customer feedback survey.

7. The customer feedback management system of claim 1, wherein the inputs reflective of that customer's experiences additionally originated from customer experiences at a different vendor of goods/services.

8. The customer feedback management system of claim 1, wherein the adjustment factor is used to determine whether a customer feedback survey will be sent to the selected customer of said plurality of customers.

9. The customer feedback management system of claim 1, wherein the at least one input device is an appointment management system of the vendor of goods/services.

10. The customer feedback management system of claim 1, wherein the at least one display device displays a summary of customer survey results over time originating from said plurality of customers.

11. The customer feedback management system of claim 1, wherein the at least one display device displays a summary of customer survey results in aggregate originating from said plurality of customers.

12. The customer feedback management system of claim 1, wherein the at least one display device displays a summary of customer survey results originating from another vendor of goods/services.

13. The customer feedback management system of claim 1, wherein the at least one display device displays a summary of customer survey results originating from the vendor of goods/services and other similar vendors of goods/services.

14. An customer feedback management device comprising:
at least one processor;
at least one display device;
at least one input device; and
at least one memory device storing a plurality of instructions which, when executed by the at least one processor, cause the at least one processor to operate with the at least one input device and the at least one display device to:
(a) receive a plurality of inputs from a plurality of customers reflective of the customer's experiences with a vendor of goods/services;
(b) for each of said plurality of customers, determine an adjustment factor to apply to the plurality of inputs for that customer to generate a normalized indication of that customer's experiences with the vendor of goods/services;
(c) receive at least one input from said vendor of goods/services reflective of a new interaction with a selected one of said plurality of customers; and
(d) display the adjustment factor for said selected customer.

15. The customer feedback management device of claim 14, wherein the at least one display device displays a summary of customer survey results over time originating from said plurality of customers.

16. The customer feedback management device of claim 14, wherein the at least one display device displays a summary of customer survey results in aggregate originating from said plurality of customers.

17. The customer feedback management device of claim 14, wherein the at least one display device displays a summary of customer survey results originating from another vendor of goods/services.

18. The customer feedback management device of claim 14, wherein the at least one display device displays a summary of customer survey results originating from the vendor of goods/services and other similar vendors of goods/services.

19. The customer feedback management device of claim 14, wherein the new interaction comprises an email.

20. An customer feedback management method for using a customer feedback management system comprising:
at least one processor;
at least one display device;
at least one input device; and
at least one memory device storing a plurality of instructions which, when executed by the at least one processor, cause the at least one processor to operate with the at least one input device, the customer feedback management method comprising:
(a) receiving a plurality of inputs from a plurality of customers reflective of the customer's experiences with a vendor of goods/services;
(b) for each of said plurality of customers, determining an adjustment factor to apply to the plurality of inputs for that customer to generate a normalized indication of that customer's experiences with the vendor of goods/services;
(c) receiving at least one input from said vendor of goods/services reflective of a new interaction with a selected one of said plurality of customers; and
(d) displaying the adjustment factor for said selected customer.
